(19) United States
(12) Patent Application Publication
(10) Pub. No.: US 2011/0180982 A1
(43) Pub. Date: Jul. 28, 2011

(54) RECEIVING UNIT FOR TOOLS OR WORKPIECES AS WELL AS A SPINDLE ARRANGEMENT FOR TOOLS OR WORKPIECES

(75) Inventor: Ulrich Baumann, Lenningen (DE)

(73) Assignee: Traub Drehmaschinen GmbH & Co. KG, Reichenbach (DE)

(21) Appl. No.: 13/082,043

(22) Filed: Apr. 7, 2011

Related U.S. Application Data
(63) Continuation of application No. PCT/EP2009/062748, filed on Oct. 1, 2009.

(30) Foreign Application Priority Data
Oct. 8, 2008 (DE) 10 2008 051 612.0

(51) Int. Cl. B23Q 3/00

(52) U.S. Cl. 269/20

(57) ABSTRACT

In order to improve a receiving unit for tools or workpieces, comprising a receiving member (14) and a clamping apparatus (30) for the tool or workpiece which is associated with it and has clamping elements (40) of a clamping device (32) arranged in a receiving area (26) of the receiving member (14) and a unit (60) for generating a clamping force, in such a manner that a more simple actuation of the clamping device (32) is possible whilst maintaining a reliable clamping of the tool or workpiece, it is suggested that the unit (60) for generating a clamping force have a supporting element (90) with a supporting surface (92), an actuator element (70) with a pressure surface (76) and a wedging element (80) which can be moved into an intermediate space (94) between the supporting surface (92) and the pressure surface (76) as a result of movement in an entry direction (96) from a release position into a pressure position in order to displace the actuator element (70) away from the supporting element (90) from a first position into a second position as a result of movement of the supporting surface (92) and the pressure surface (76) away from one another and which can be secured in the pressure position and the release position and moved from one position to the other by means of a slide element (110) which has a connecting link path (112) for acting on the wedging element (80).

This application is a continuation of international application number PCT/EP2009/062748 filed on Oct. 1, 2009.

This patent application claims the benefit of International application No. PCT/EP2009/062748 of Oct. 1, 2009 and German application No. 10 2008 051 612.0 of Oct. 8, 2008, the teachings and disclosure of which are hereby incorporated in their entirety by reference thereto.

### BACKGROUND OF THE INVENTION

The invention relates to a receiving unit for tools or workpieces, comprising a receiving member and a clamping apparatus for the tool or workpiece which is associated with it and has clamping elements of a clamping device arranged in a receiving area of the receiving member and a unit for generating a clamping force.

Receiving units of this type are known from the state of the art, wherein the unit for generating a clamping force is normally a hydraulic cylinder, with which the clamping device is acted upon, namely such that the tool or workpiece is clamped as a result of the clamping device being constantly acted upon, i.e. constant action of the hydraulic cylinder, wherein the hydraulic cylinder has to be constantly acted upon with hydraulic medium for this purpose.

Proceeding from this state of the art, the object underlying the invention is to improve a receiving unit of the generic type in such a manner that a more simple actuation of the clamping device is possible whilst maintaining a reliable clamping of the tool or workpiece.

### SUMMARY OF THE INVENTION

This object is accomplished in accordance with the invention, in a receiving unit of the type described at the outset, in that the unit for generating a clamping force has a supporting element with a supporting surface, an actuator element with a pressure surface and a wedging element which can be moved into an intermediate space between the supporting surface and the pressure surface as a result of movement in an entry direction from a release position into a pressure position in order to displace the actuator element in the direction away from the supporting element from a first position into a second position and vice versa as a result of the supporting surface and the pressure surface being moved away from one another, and the wedging element can be secured in the pressure position and the release position and moved from one position to the other by means of a slide element which has a connecting link path for acting on the wedging element.

The advantage of the solution according to the invention is to be seen in the fact that a simple possibility exists, as a result of the connecting link path, of moving the wedging element between the release position and the pressure position and vice versa and that, on the other hand, movement of the actuator element can be generated in a simple manner as a result of the wedging element.

Such a solution also allows, in particular, the generation of a considerable force acting on the clamping elements.

With respect to the course or the alignment of the entry direction, no further details have so far been given.

In principle, the entry direction could extend approximately parallel to a central axis of the receiving member.

It is, however, particularly favorable when the entry direction extends transversely to the central axis of the receiving member, in particular at right angles to the central axis of the receiving member, since, as a result, a conversion of the movement of the wedging member into a movement of the actuator element and, therefore, a movement of the clamping device can be realized in a simple manner.

In principle, it would be conceivable for the supporting element to be fixed stationarily in place, for example be fixed stationarily in place on a carrier tube of the unit for generating a clamping force and, therefore, be arranged so as to be non-displaceable relative to the central axis of the receiving member.

One particularly advantageous solution provides for the supporting element to be supported by an elastic spring supporting unit.

This solution is particularly favorable when the supporting element can be moved away from the actuator element and the elastic spring supporting unit of the supporting element transfers from a non-tensioned state into a tensioned state during the transition of the wedging element from the release position into the pressure position.

This tensioned state may be exploited advantageously, in particular, when the elastic spring supporting unit, in the pressure position of the wedging element, generates a clamping force, with which the actuator element acts in the direction of the second position.

As a result, it is possible, first of all, to intensify the force which acts on the wedging element in a simple manner and, on the other hand, it is possible to provide a clamping force for actuating the clamping device which offers the possibility of acting constantly on the clamping device.

On the other hand, in order to also ensure that the unit for generating a clamping force releases the clamping device, namely when the wedging element is in its release position, it is preferably provided for the actuator element to be acted upon with a spring force in the direction of the first position.

With respect to the design of the supporting surface, no further details have so far been given. One advantageous solution, for example, provides for the supporting surface to extend at an acute angle in relation to the entry direction.

Furthermore, it is preferably provided for the pressure surface to extend at an acute angle in relation to the entry direction.

The wedging element can be designed in the most varied of ways.

In this respect, it is preferably provided for the wedging element to have at least one wedging surface extending at an acute angle to the entry direction.

In this respect, the wedging element could itself be designed, for example, as a wedge.

It is, however, particularly advantageous when the wedging element is designed as a sphere since a sphere is a member which is easy to produce and can be moved relative to the pressure surface and to the supporting surface and/or on the pressure surface and on the supporting surface in a low-friction manner on account of its small contact surfaces.

In order to have considerable forces available, in particular, for actuating the clamping apparatus, it is preferably provided for the wedging element to travel a distance in the entry direction between the release position and the pressure position which is greater than the distance, via which the actuator element can be moved between the first position and the second position.

It is, therefore, possible with this solution to intensify the pressure acting on the wedging element even more.

Further details have not been given concerning the type and design of the connecting link path in conjunction with the preceding explanations concerning the individual embodiments.

One advantageous solution provides for the connecting link path of the slide element to be designed such that a sliding distance which the slide element travels between the first position and the second position is greater than the distance of the wedging element between the release position and the pressure position.

A solution is particularly favorable, with which the unit for generating a clamping force is designed to be self-locking in the first and the second positions since, as a result, it is possible not to act constantly on the unit for generating a clamping force with a unit for generating a force when the first position or the second position is reached and so the unit for generating a clamping force will retain the respective position even without any force acting on it and, for example, in the second position keep the clamping elements constantly acted upon with a force without the unit for generating a clamping force, in particular the slide element, needing to be acted upon constantly.

This may be achieved with the solution according to the invention, for example, in that the sections of the connecting link path securing the release position and the pressure position extend parallel to the direction of displacement of the slide element.

In order to be able to actuate the slide element in a simple manner, it is preferably provided for the slide element to be movable between the first position and the second position by means of an actuating unit comprising a linear drive.

With respect to the design of the linear drive, the most varied of possibilities are conceivable.

One advantageous solution, for example, provides for the linear drive to be an electrical drive.

An alternative solution provides for the linear drive to be a fluid-driven drive.

In addition, the invention also relates to a spindle arrangement comprising a spindle housing and a spindle mounted for rotation in the spindle housing and having a receiving unit for a tool or workpiece, wherein the spindle is provided in accordance with the invention with a receiving unit for the tool or the workpiece as defined in any one of the preceding claims.

Such a spindle arrangement is designed, in particular, such that an element of an actuating unit acting on the slide element of the receiving unit co-rotates with the spindle.

Such a solution is particularly advantageous when the slide element can be moved by an electrical actuating unit so that the fact can be exploited that a force can be applied to the element of the actuating unit movable with the slide element in a non-contact manner with such an electrical actuating unit and, therefore, a non-contacting transfer of force between an element co-rotating with the spindle and a stationary element is possible.

For this purpose, it is provided, in particular, for the electrical actuating unit to have an actuator which is connected to the slide element and co-rotates with the spindle and a stator which is arranged on the spindle housing.

Alternatively thereto, it is conceivable for the slide element to be movable by means of a fluid-driven actuating unit.

In this case, it is preferably provided for the fluid-driven actuating unit to be coupled via rotary bearings to the actuator element, i.e., for the slide element to be coupled via rotary bearings relative to a stationary actuator not co-rotating with the spindle and a stationary stator likewise not co-rotating with the spindle on account of its coupling to the spindle.

Additional features and advantages are the subject matter of the following description as well as the drawings illustrating several embodiments.

### BRIEF DESCRIPTION OF THE DRAWINGS

FIG. 1 shows a longitudinal section through a first embodiment of a spindle arrangement according to the invention with a clamping device located in a first position and a wedging member located in a release position;

FIG. 2 shows a section along line 1-1 of the first embodiment with an actuator located in a second position and a wedging member located in a pressure position;

FIG. 3 shows a section similar to FIG. 1 through a second embodiment of a spindle arrangement according to the invention with an actuator located in the first position and

FIG. 4 shows a section similar to FIG. 2 through the second embodiment with an actuator located in the second position.

### DETAILED DESCRIPTION OF THE INVENTION

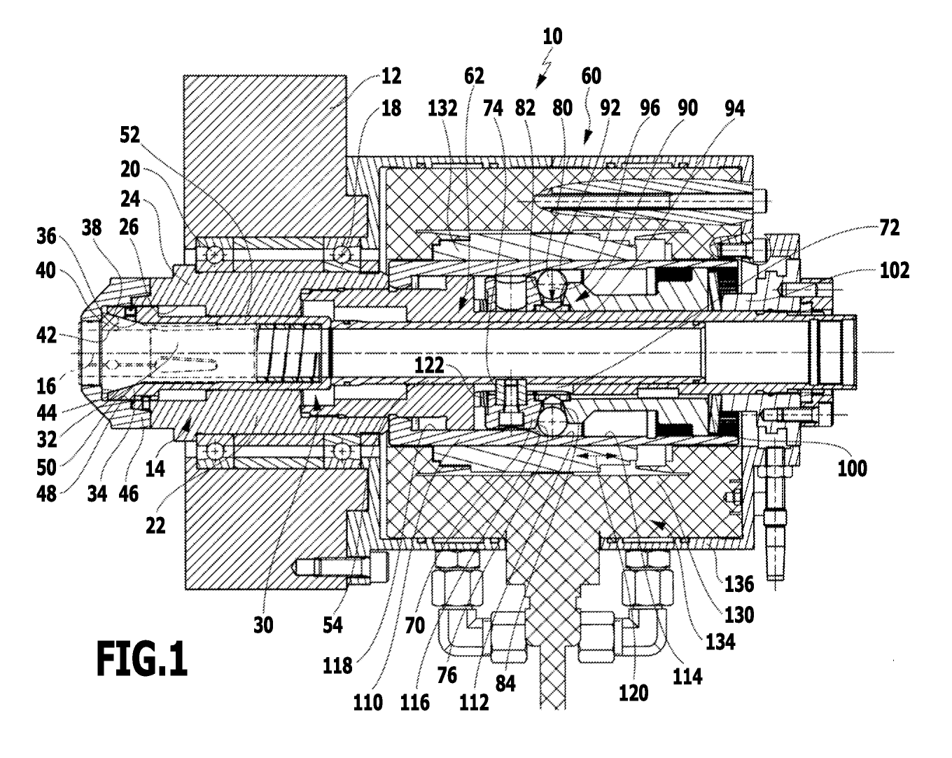

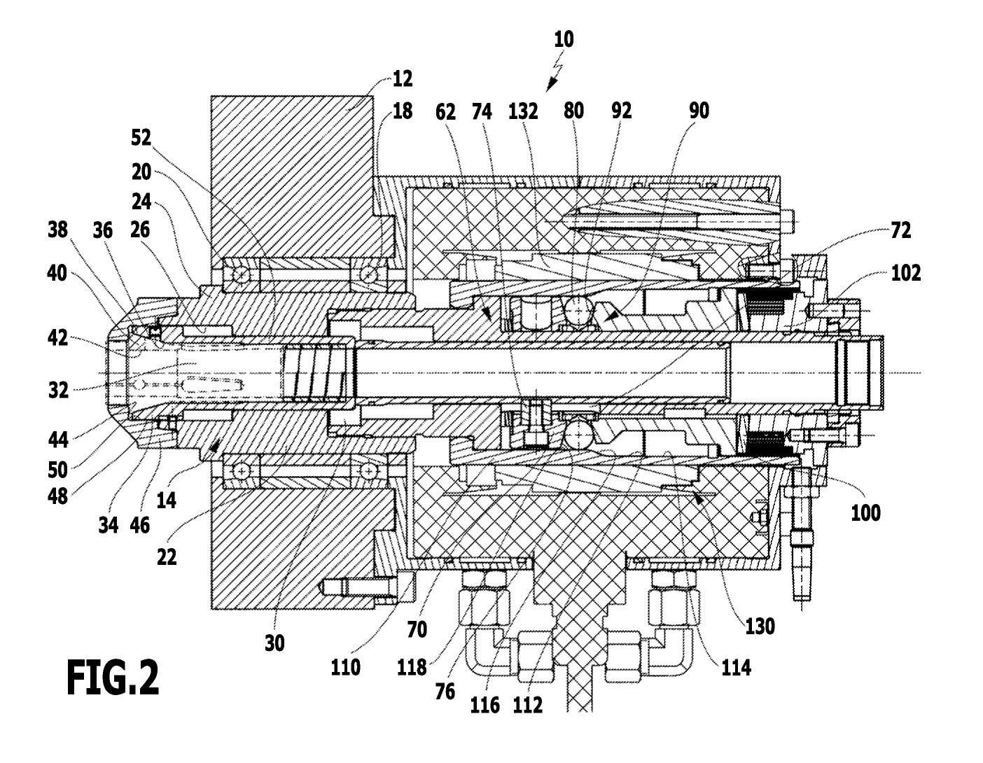

A first embodiment of a spindle arrangement 10 according to the invention, illustrated in FIGS. 1 and 2, comprises a spindle housing 12, in which a spindle 14 is mounted for rotation about a spindle axis 16 by means of rotary bearings 18 and 20.

The spindle 14 comprises a spindle guard tube 22 which is mounted in the rotary bearings 18 and 20 and has in a front area 24 a recess 26, in which a clamping device 32 of a clamping apparatus designated as a whole as 30 is arranged, wherein the clamping device 32 is designed in the embodiment illustrated as a so-called push-out collet chuck which has, on the one hand, pressure jaws 34 which are provided with inclined surfaces 36 and are, with these inclined surfaces 36, in a position to act on corresponding outer surfaces 38 of clamping jaws 40 and, therefore, to move the clamping jaws 40 with their clamping surfaces radially towards the spindle axis 16 in order to clamp a workpiece or a tool with the clamping surfaces 42 of the clamping jaws 40.

The clamping jaws 40 abut on a contact surface 44 of a retainer nut of the spindle 14 which is designated as a whole as 46, is located on the front side and prevents the clamping jaws 40 from moving out of the recess 26 in the direction of the spindle axis 16, especially when the pressure jaws 34 are moved in the direction of the retainer nut 46 in order to move the clamping jaws 40 with the inclined surfaces 36 radially to the spindle axis 16 in the direction thereof.

The pressure jaws 34 are supported, for their part, with an outer side 48 on an inner surface 50 of the retainer nut 46 on the front side, this inner surface extending cylindrically to the spindle axis 16.

The pressure jaws 34 can be moved in the direction of the spindle axis 16 by a pressure sleeve which is designated as a whole as 52, wherein the pressure sleeve 52 is acted upon by a pressure pipe which is designated as 54 and is part of a unit 60 for generating a clamping force which is arranged on and adjoins a side of the spindle 14 located opposite the retainer nut 46.

The unit 60 for generating a clamping force comprises, in addition, a carrier tube 62 which is connected to the spindle guard tube 22, is held by the spindle guard tube 22 and co-rotates with it, wherein the pressure pipe 54 extends within the carrier tube 62 and is guided by the carrier tube 62.

An actuator element designated as a whole as 70 is seated on a side of the carrier tube 62 facing away from the pressure pipe 54 and located radially outwards, this actuator element being rigidly connected to the pressure pipe 54 via a coupling element 74 which passes through a recess 72 in the carrier tube 62 and, therefore, also being displaceable in the direction of the spindle axis 16 together with the pressure pipe 54.

In this respect, the actuator element 70 is provided with a pressure surface 76 which faces a wedging element 80 so that the wedging element 80 can act on the pressure surface 76 of the actuator element 70 with a wedging surface 82.

Furthermore, a second wedging surface 84 of the wedging element 80 is provided on a side of the wedging element 80 located opposite the wedging surface 82 and the second wedging surface faces a supporting element which is designated as a whole as 90 and, for its part, bears a supporting surface 92 which faces the second wedging surface 84.

In this respect, an intermediate space 94 is formed between the supporting surface 92 and the pressure surface 76, which the wedging element 80 can enter to a greater or lesser extent, wherein for this purpose the wedging element 80 is to be moved in the direction of an entry direction 96 which extends transversely to the spindle axis 16, preferably radially and, therefore, at right angles to it.

The supporting element 90 is likewise seated on the carrier tube 62, namely on a side thereof which faces away from the pressure pipe 54, is located radially outwards, is movable relative to it and is supported via an elastic spring supporting unit 100 on a counter bearing ring 102 which is seated on the carrier tube 62 and fixed to it, wherein the elastic spring supporting unit 100 is formed, in the simplest case, by a plate spring which can be tensioned as a result of the fact that the supporting element 90 moves in the direction of the counter bearing ring 102.

In order to move the wedging member 80 in the entry direction 96, a slide element is provided which is designated as a whole as 110, preferably engages over both the actuator element 70 and the supporting element 90 on its side facing away from the carrier tube 62 and, on a side facing the wedging element 80, bears a connecting link path 112, with which the wedging element 80 can be acted upon; in this respect, the connecting link path 112 has a path section 114 which extends essentially parallel to the spindle axis 16 and is located radially outwards with respect to the spindle axis 16, a transition section 116 which adjoins the path section 114 which is located radially outwards and a path section 118 which is located radially inwards with respect to the spindle axis 16.

As a result of movement of the slide element 110 in a direction of displacement 120 which extends parallel to the spindle axis 16, it is now possible to act on the wedging element 80 either with the path section 114 of the connecting link path 112 which is located radially outwards, the transition section 116 or the path section 118 which is located radially inwards.

As long as the connecting link path 112 acts on the wedging element 80 with the path section 114 which is located radially outwards, this wedging element is in a so-called release position, in which the wedging element takes up a position relative to the spindle axis 16 which is located radially outwards to the maximum.

If the slide element 110 is now displaced in the direction of displacement 120 such that it is not the path section 114 located radially outwards which acts on the wedging element 80 but rather the transition section 116, this causes an increasing displacement of the wedging element 80 in the entry direction 96, i.e. into the intermediate space 94 between the supporting surface 92 of the supporting element 90 and the pressure surface 76 of the actuator element 70. If, as a result of further displacement of the slide element 110 in the direction of displacement 120 the connecting link path 112 is displaced to such an extent that the path section 118 which is located radially inwards acts on the wedging element 80, the wedging element 80 is in its position located inwards to the maximum with respect to the spindle axis 16 and has moved into the intermediate space 94 in the entry direction 96 to such an extent that the pressure surface 76 and the supporting surface 92 are pressed apart from one another by the wedging element 80 with the wedging surfaces 82 and 84. In this position, the wedging element is in its so-called pressure position.

The movement of the pressure surface 76 and the supporting surface 92 away from one another results in the supporting element 90 being moved in the direction of the counter bearing ring 102 and the elastic spring supporting unit 100 thereby being tensioned. Moreover, at the same time the actuator element 70 will be moved away from the supporting element 90 in the direction of the spindle guard tube 22 and the pressure sleeve 52 on account of the action on the pressure surface 76 and, on account of the coupling element 74, thereby causes the pressure pipe 54 to also be moved in the direction of the spindle guard tube 22 to the same extent as the actuator element 70.

Since the pressure pipe 54 interacts with the pressure sleeve 52, in particular is in a position to act on the pressure sleeve 52 in the direction of the retainer nut 46, the movement of the pressure pipe 54 leads to an identical movement of the pressure sleeve 52 and, therefore, of the pressure jaws 34 in the direction of the retainer nut 46, wherein the pressure jaws 34 act on the clamping jaws 40 in the manner already described such that they move radially inwards towards the spindle axis 16.

Since, during the transition of the wedging member 80 from the release position into the pressure position, the supporting element 90 has also moved in the direction of the counter bearing ring 102 and the elastic spring supporting unit 100 has become tensioned, the elastic spring supporting unit 100, in the pressure position of the wedging element 80, also acts via the supporting element 90 on the wedging member 80 and the actuator element 70 on the pressure pipe 54 and, therefore, the pressure sleeve 52 with the pressure jaws 34, as well, so that, in the end, the pressure jaws 34 are acted upon with the clamping force of the elastic spring supporting unit 100 in the pressure position of the wedging member 80 and move the clamping jaws 40 radially towards the spindle axis 16 on account of the action of this clamping force.

When the pressure jaws 34 interact with the clamping jaws 40, the force acting on the pressure pipe 54 in the direction of the retainer nut 46 is preferably intensified to form a clamping force which acts radially inwards in the area of the clamping surfaces 42 and is greater than the force acting on the pressure pipe 54 in the direction of the retainer nut 46 so that, in the end, this clamping force is greater than the force acting on the pressure pipe 54 in an axial direction parallel to the spindle axis 16.

If the tool or workpiece fixed in the clamping device 32 by the clamping jaws 40 is intended to be released, the slide element 110 will be displaced in the direction of displacement 120 to such an extent that it is no longer the path section 118 of the slide element 110, which is located inwards, which acts on the wedging element 80 but rather the path section 114 which is located outwards and so the wedging element 80 transfers from the pressure position into its release position and, therefore, moves out of the intermediate space 94 at least partially contrary to the entry direction 96.

As a result, the pressure surface 76 and the supporting surface 92 have the possibility of moving towards one another in the direction of the spindle axis 16 with the aid of the spring elements 122, thereby reducing the extension of the intermediate space 94, and so, on the one hand, the supporting element 90 can be withdrawn from the counter bearing ring 102 so that a relaxation of the elastic spring supporting unit 100 occurs and, on the other hand, the actuator element 70 can move away from the spindle guard tube 22 as a result of the action of the spring elements 122 and so the pressure pipe 54 moves accordingly and, therefore, moves away from the retainer nut 46. As a result, the pressure sleeve 52 can, at the same time, move away from the retainer nut 46 in the same direction and, therefore, the pressure jaws 34, as well, to a corresponding extent and so, in return, the clamping jaws 40 can also move radially outwards in order to release the workpiece or the tool.

A non-clamping position of the clamping device 32 therefore corresponds to the release position of the wedging element 80 while the position of the clamping device 32 clamping a workpiece or tool corresponds to the pressure position of the wedging element 80.

In order to be able to move the slide element 110 in the direction of displacement 120, the slide element 110, in the embodiments illustrated in FIGS. 1 and 2, is connected on its side located opposite the connecting link path 112 to an actuator 132 of an actuating unit which is designated as a whole as 130 and comprises, in the embodiment illustrated in FIGS. 1 and 2, an electrical linear drive which has, in addition to the actuator 132, a stator 134 which can be activated such that the actuator 132 can move in the direction of displacement 120 such that the slide element 110 is movable between a first slide position, illustrated in FIG. 1, which brings about the release position of the wedging element 80 and a second slide position, illustrated in FIG. 2, which brings about and maintains the pressure position of the wedging element 80, wherein the actuator 132 and the slide element 110 are rigidly coupled to one another.

In view of the fact that the carrier tube 62 co-rotates with the spindle 14, the slide element 110 seated on the carrier tube 62 and the actuator 132 will co-rotate with the spindle 14 during its rotating drive.

In contrast thereto, the stator 134 does not co-rotate with the spindle 22 but is arranged stationarily and is seated, for example, in a stator housing 136 which is connected non-rotatably, for example, to the spindle housing 12.

On account of the non-contact action of the stator 134 on the actuator 132 it is possible to move the actuator 132 in the direction of displacement 120 and, therefore, the slide element 110 into the desired position, as well, without any friction occurring in the actuating unit 130 between the stator 134 and the actuator 132, wherein no losses of friction result despite the fact that the actuator 132 co-rotates with the spindle 22 whereas the stator 134 is connected stationarily to the spindle housing 12.

As a result, it is possible to move the actuator 132 in the direction of displacement 120 and, therefore, also the slide element 110 in the direction of displacement 120 via the stator 134 which is provided stationarily and, in this case, can also be supplied, for example, with current in a simple manner and, therefore, activated, wherein the actuator 132 preferably remains in the first position or the second position together with the slide element 110.

The clamping apparatus is preferably designed to be self-locking, i.e. the slide element 110 with the actuator 132 will not leave either the first position or the second position of the clamping apparatus 30 without any external action.

If an additional securing of the position of the slide element 110 is intended to take place, it is possible to supply the stator 134 with current such that it is still supplied with a slight current when the first position and/or the second position of the slide element 110 is reached and, therefore, the first position or the second position of the actuator 132 and so this slight current leads to an additional holding force in the first and/or the second position of the actuator 132 and the slide element 110 cannot, therefore, move out of the position, into which it has been brought as a result of the stator 134 being supplied with current and, therefore, the actuator 132 moved.

Altogether, it is possible as a whole to move the clamping device 32 back and forth between its position clamping a tool or workpiece by means of the clamping jaws 40 or its position releasing a tool or workpiece with the clamping jaws 40 as a result of movement of the slide element 110 by means of the actuator 132, wherein the advantage is to be seen in the fact that the slide element 110 maintains the first or second position in a self-locking manner on account of the interaction of the connecting link path 112 with the wedging element 80 and, therefore, in principle, no special resources are required for maintaining the first position or the second position of the slide element 110.

In a second embodiment of a spindle arrangement according to the invention, those parts which are identical to those of the first embodiment are provided with the same reference numerals and so reference can be made in full to the explanations concerning the first embodiment with respect to the description and the functioning of these parts.

In contrast to the first embodiment, the slide element 110 is movable in the direction of displacement 120 with an actuating unit which is designated as a whole as 130′ and operates pneumatically.

For this purpose, the actuating unit 130′ comprises as actuator 132′ a sleeve 142 with a piston 144 which is located radially outwards and engages in a cylinder chamber 146 of a cylinder housing 150, wherein the cylinder chamber 146 is closed in the cylinder housing 150 at its side located radially inwards by the sleeve 142 which bears the annular piston 144.

The sleeve 142 is coupled to the slide element 110 so as to be rotatable, namely, for example, due to the fact that the sleeve 142 has a projection 160 which is located radially inwards and is arranged between two rotary bearings 162 and 164 so as to be non-displaceable in the direction of the spindle axis 12, wherein the rotary bearings 162, 164 provide a rotatable connection between the actuator 132′ and the slide element 110 which is, however, rigid in the direction of displacement 120. The rotary bearings 162 and 164 are, for this purpose, arranged and fixed, for example, on an outer side of the slide element 110 which is located radially outwards and accommodate the projection 160 between them.

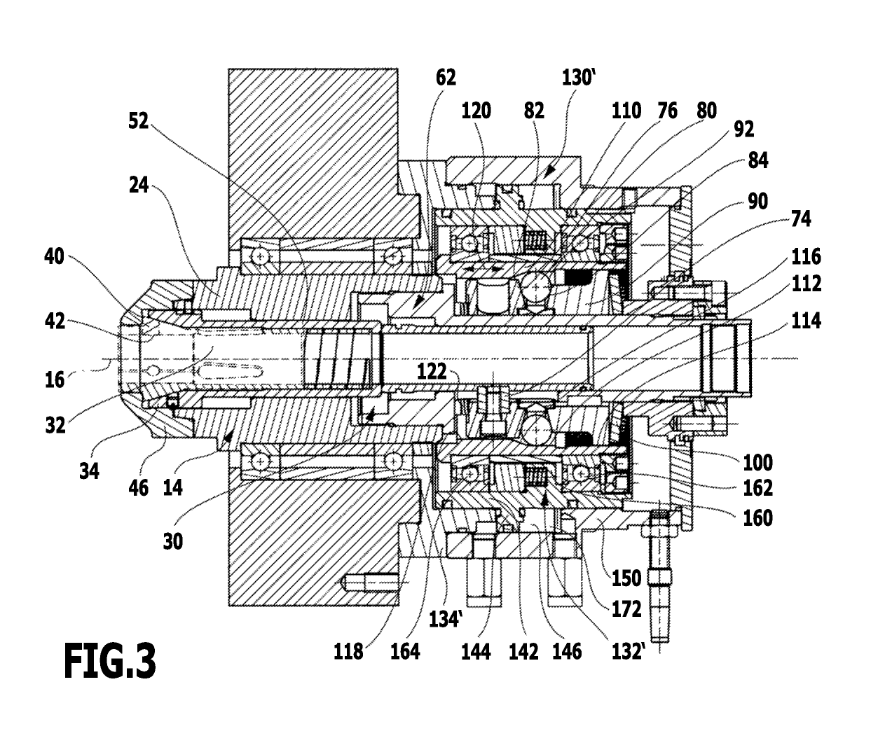

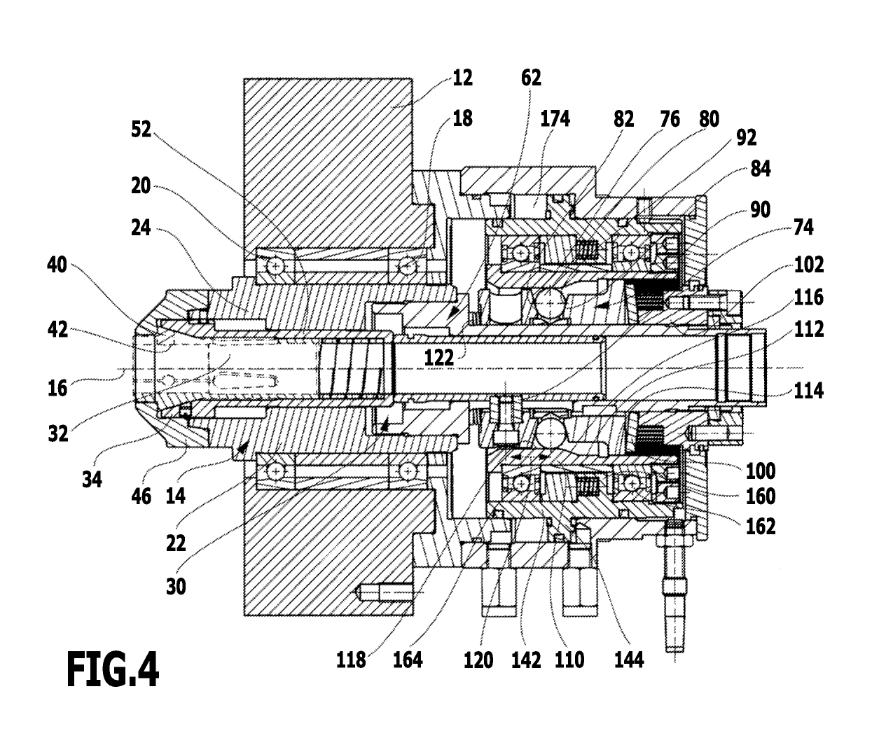

As a result of the fact that the annular piston 144 divides the cylinder chamber 146 into two cylinder chambers 172 and 174, the piston 144 is movable into two positions, for example, pneumatically by way of alternating action on the cylinder chambers 172 and 174, wherein in the position illustrated in FIG. 3, in which the cylinder chamber 172 is acted upon pneumatically, the piston 144 holds the slide element 110 in the first position and in the position illustrated in FIG. 4, in which the cylinder chamber 174 is acted upon pneumatically, the piston 144 holds the slide element 110 in the second position.

In contrast to the first embodiment, the cylinder housing 150 corresponding to a stator 134′ and the actuator 132′ comprising an annular piston 144 are stationary, i.e. not arranged so as to co-rotate with the spindle 14, wherein the rotatable coupling between the stator 132′ and the slide element 110 is brought about by the rotary bearings 162 and 164.

1. Receiving unit for tools or workpieces, comprising a receiving member and a clamping apparatus for the tool or workpiece associated with it and having clamping elements of a clamping device arranged in a receiving area of the receiving member and a unit for generating a clamping force,
wherein the unit for generating a clamping force having a supporting element with a supporting surface, an actuator element with a pressure surface and a wedging element movable into an intermediate space between the supporting surface and the pressure surface as a result of movement in an entry direction from a release position into a pressure position in order to displace the actuator element away from the supporting element from a first position into a second position as a result of movement of the supporting surface and the pressure surface away from one another, and said wedging element also being securable in the pressure position and the release position and being movable from one position to the other by means of a slide element with a connecting link path for acting on the wedging element.

2. Receiving unit as defined in claim 1, wherein the entry direction extends transversely to a central axis of the receiving member.

3. Receiving unit as defined in claim 1, wherein the supporting element is supported by an elastic spring supporting unit.

4. Receiving unit as defined in claim 3, wherein during the transition of the wedging element from the release position into the pressure position the supporting element is movable away from the actuator element and the elastic spring supporting unit of the supporting element transfers from a non-tensioned state into a tensioned state.

5. Receiving unit as defined in claim 4, wherein in the pressure position of the wedging element the elastic spring supporting unit generates a clamping force causing the actuator element to act in the direction of the second position.

6. Receiving unit as defined in claim 1, wherein the actuator element is acted upon with a spring force in the direction of the first position.

7. Receiving unit as defined in claim 1, wherein the supporting surface extends at an acute angle in relation to the entry direction.

8. Receiving unit as defined in claim 1, wherein the pressure surface extends at an acute angle in relation to the entry direction.

9. Receiving unit as defined in claim 1, wherein the wedging element has at least one wedging surface extending at an acute angle to the entry direction.

10. Receiving unit as defined in claim 1, wherein the wedging element is designed as a sphere.

11. Receiving unit as defined in claim 1, wherein between the release position and the pressure position the wedging element travels a distance in the entry direction greater than the distance the actuator element is movable between the first position and the second position.

12. Receiving unit as defined in claim 1, wherein the connecting link path of the slide element is designed such that a sliding distance traveled by the slide element between the first position and the second position is greater than the distance of the wedging element between the release position and the pressure position.

13. Receiving unit as defined in claim 1, wherein the unit for generating a clamping force is designed to be self-locking in the first and the second positions.

14. Receiving unit as defined in claim 1, wherein the slide element is movable between the first position and the second position by means of an actuating unit comprising a linear drive.

15. Receiving unit as defined in claim 14, wherein the linear drive is an electrical linear drive.

16. Receiving unit as defined in claim 14, wherein the linear drive is a fluid-driven linear drive.

17. Spindle arrangement comprising a spindle housing and a spindle mounted for rotation in the spindle housing and having a receiving unit for a tool or workpiece, wherein the spindle is provided with a receiving unit for the tool or workpiece as defined in claim 1.

18. Spindle arrangement as defined in claim 17, wherein an element of an actuating unit acting on the slide element of the receiving unit co-rotates with the spindle.

19. Spindle arrangement as defined in claim 17, wherein the slide element is movable by means of an electrical actuating unit.

20. Spindle arrangement as defined in claim 19, wherein the electrical actuating unit has an actuator connected to the slide element and co-rotatable with the spindle and a stator arranged on the spindle housing.

21. Spindle arrangement as defined in claim 17, wherein the slide element is movable by means of a fluid-driven actuating unit.
